(19) United States
(12) Patent Application Publication
(10) Pub. No.: US 2026/0240706 A1
(43) Pub. Date: Aug. 20, 2026

(54) Portable Massage Support Device

(71) Applicant: Lindy Tasker-Evans, North Albury (AU)

(72) Inventor: Lindy Tasker-Evans, North Albury (AU)

(21) Appl. No.: 19/648,452

(22) Filed: Apr. 15, 2026

Related U.S. Application Data
(63) Continuation-in-part of application No. 18/369,640, filed on Sep. 18, 2023.

(51) Int. Cl. A61G 15/12; A61G 15/00

(52) U.S. Cl. CPC A61G 15/125; A61G 15/007; A61G 2200/34

(57) ABSTRACT

A portable massage support device includes a frame that has a pair of first members each hingedly coupled to a pair of second members and a support bracket pivotally coupled to the pair of first members. A leg cushion is attached to the pair of second members to rest upon a user's thighs when the user is seated in a chair and a torso cushion is slidably disposed on the pair of first members to orient the user in a preferred orientation to receive a back massage. A face cushion bracket is removably attachable to the torso cushion and a face cushion is coupled to the face cushion bracket to support the user's face when the user is seated in the chair.

### (B) CROSS-REFERENCE TO RELATED APPLICATIONS

This application is a continuation in part of application Ser. No. 18/369,640 filed Sep. 18, 2023.

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to massage support devices and more particularly pertains to a new massage support device for supporting a user in a forward leaning position to receive a back massage. The device includes a frame and a torso cushion attached to the frame and a leg cushion attached to the frame and a face cushion spaced upwardly from the torso cushion. The frame is positionable at an angle such that the leg cushion rests on the user's thighs and the user's torso rests on the torso cushion and the user's face rests on the face cushion to retain the user in a forward leaning position to receive a back massage.

### (2) Description of Related Art Including Information Disclosed Under 37 CFR 1.97 and 1.98

The prior art relates to massage support devices including a variety of massage chair devices that each includes a seat to support a user and a support structure to support the user in a forward leaning position. In no instance does the prior art disclose a massage support device that includes a frame that includes a torso cushion for supporting a user's torso and a leg cushion that abuts the user's legs and a face cushion to support the user's face to support the user in a forward leaning position while the user is seated in a chair of any conventional design.

### (H) BRIEF SUMMARY OF THE INVENTION

An embodiment of the disclosure meets the needs presented above by generally comprising a frame that has a pair of first members each hingedly coupled to a pair of second members and a support bracket pivotally coupled to the pair of first members. A leg cushion is attached to the pair of second members to rest upon a user's thighs when the user is seated in a chair and a torso cushion is slidably disposed on the pair of first members to orient the user in a preferred orientation to receive a back massage. A face cushion bracket is removably attachable to the torso cushion and a face cushion is coupled to the face cushion bracket to support the user's face when the user is seated in the chair.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a portable massage support device according to an embodiment of the disclosure.

FIG. 2 is a back view of an embodiment of the disclosure.

FIG. 3 is a front view of an embodiment of the disclosure.

FIG. 4 is a left side view of an embodiment of the disclosure.

FIG. 5 is a left side view of an embodiment of the disclosure showing extension members in a deployed position.

FIG. 6 is a perspective in-use view of an embodiment of the disclosure.

### (J) DETAILED DESCRIPTION OF THE INVENTION

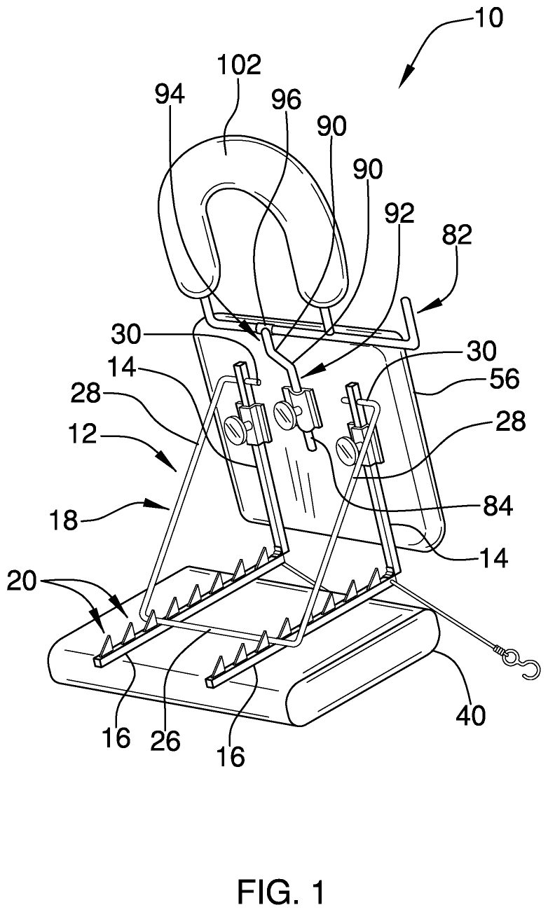

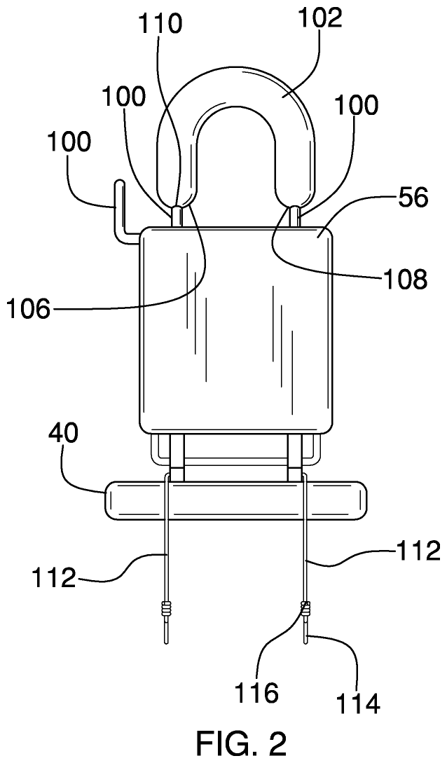

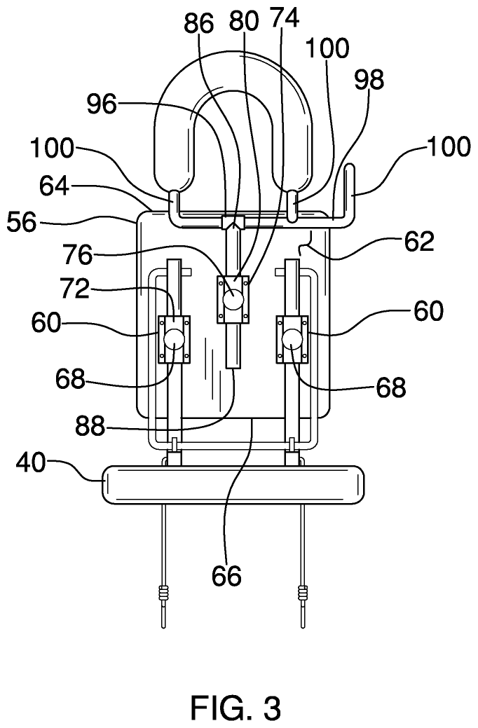

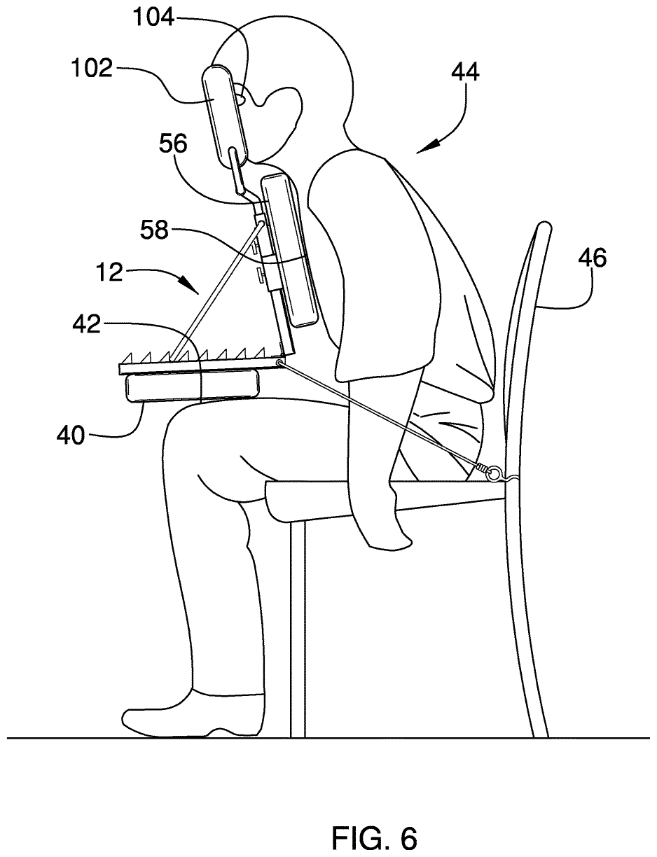

With reference now to the drawings, and in particular to FIGS. 1 through 6 thereof, a new massage support device embodying the principles and concepts of an embodiment of the disclosure and generally designated by the reference numeral 10 will be described.

As best illustrated in FIGS. 1 through 6, the portable massage support device 10 generally comprises a frame 12 that has a pair of first members 14 hingedly coupled to a pair of second members 16 and a support bracket 18 pivotally coupled to the pair of first members 14. The support bracket 18 is positionable to engage a respective one of the plurality of engagement points 20 on the pair of second members 16 for retaining the pair of first members 14 at an adjustable angle with the pair of second members 16. Additionally, a lower end 22 of each of the pair of first members 14 is hingedly attached to a rear end 24 of a respective one of the pair of second members 16. The support bracket 18 has a center member 26 extending between and being perpendicularly oriented with a pair of outward members 28. The support bracket 18 includes a pair of feet 30 extending laterally away from a respective one of the outward members 28 having the feet 30 being directed toward each other. Each of the pair of feet 30 is distally located with respect to the center member 26 and each of the pair of feet 30 extends laterally through a respective one of the first members 14 of the frame 12 such that the center member 26 rests on the pair of second members 16.

The frame 12 includes a plurality of stops 32 each extending upwardly from a top surface 34 of a respective one of the second members 16 such that the plurality of stops 32 defines the plurality of engagement points 20. The stops 32 are spaced apart from each other and are distributed along a full length of the respective second member 16. Additionally, each of the plurality of stops 32 has a back edge 36 that is perpendicularly oriented with the top surface 34 of the respective second member 16 and a front edge 38 which slopes between the back edge 36 and the top surface 34. Furthermore, the support bracket 18 is positionable in a deployed position having the center member 26 resting against the back edge 36 of a respective pair of the stops 32 for retaining the pair of first members 14 at a selected angle with the pair of second members 16.

A leg cushion 40 is attached to the pair of second members 16 of the frame 12 and the leg cushion 40 rests upon thighs 42 of a user 44 when the user 44 is seated in a chair 46. The leg cushion 40 has an upper surface 48 that is attached to a bottom surface 50 of the pair of second members 16. Each of the pair of second members 16 extends outwardly beyond each of a forward side 52 and a rear side 54 of the leg cushion 40. A torso cushion 56 is slidably disposed on the pair of first members 14 and the user's torso 58 rests against the torso cushion 56 when the user 44 is seated in the chair 46 thereby orienting the user 44 in a preferred orientation to receive a back massage. Additionally, the torso cushion 56 is adjustable on the pair of first members 14 to accommodate various sizes of users. The leg cushion 40 may have a fluid impermeable outer covering and the torso cushion 56 may have a fluid impermeable outer covering to protect each of the leg cushion 40 and the torso cushion 56 from bodily fluids.

A pair of first sleeves 60 is provided and each of the first sleeves 60 is attached to a rear surface 62 of the torso cushion 56. Each of the pair of first sleeves 60 is oriented to extend along a line extending between an upper side 64 and a lower side 66 of the torso cushion 56. Additionally, the first sleeves 60 are spaced apart from each other and are aligned with each other on the rear surface 62. Each of the pair of first sleeves 60 slidably receives a respective one of the first members 14 of the frame 12 for slidably attaching the torso cushion 56 to the pair of first members 14. In this way the torso cushion 56 can be slid upwardly or downwardly on the pair of first members 14 to accommodate the user 44.

A pair of first knobs 68 is provided and each of the pair of first knobs 68 includes a threaded shaft 70 which extends through an outer wall 72 of a respective one of the pair of first sleeves 60. The threaded shaft 70 of each of the first knobs 68 compresses against the first member 14 in the respective first sleeve 60 when the first knobs 68 are tightened for retaining the torso cushion 56 at a desired position along the pair of first members 14. The threaded shaft 70 of each of the first knobs 68 is urged away from the respective first member 14 when the first knobs 68 are loosened to facilitate the torso cushion 56 to be adjusted on the first members 14.

A second sleeve 74 is provided and the second sleeve 74 is attached to the rear surface 62 of the torso cushion 56. The second sleeve 74 is positioned between the pair of first sleeves 60 and the second sleeve 74 is oriented parallel to the pair of first sleeves 60. A distance between the second sleeve 74 and the upper side 64 of the torso cushion 56 is less than a distance between the pair of first sleeves 60 and the upper side 64. A second knob 76 is provided which has a threaded shaft 78 that extends through an outer wall 80 of the second sleeve 74.

A face cushion bracket 82 is removably attachable to the torso cushion 56 having the face cushion bracket 82 extending upwardly from the torso cushion 56. The face cushion bracket 82 comprises an attaching member 84 that has a coupled end 86 and a free end 88. The attaching member 84 has a pair of bends 90 forming angles that are congruent with each other thereby defining a lower portion 92 that is oriented parallel to an upper portion 94. The free end 88 is associated with the lower portion 92 and the coupled end 86 is associated with the upper portion 94. The lower portion 92 is insertable through the second sleeve 74 and the threaded shaft 78 of the second knob 76 compresses against the lower portion 92 when the second knob 76 is tightened for retaining the lower portion 92 at a selected height in the second sleeve 74.

The face cushion bracket 82 includes a collar 96 that is attached to the coupled end 86 having the collar 96 being perpendicularly oriented with the upper portion 94 of the attaching member 84. The face cushion bracket 82 includes a cross member 98 which extends through the collar 96 such that the cross member 98 is perpendicularly oriented with the upper portion 94 of the attaching member 84. The cross member 98 has a plurality of fingers 100 each extending upwardly from the cross member 98. The fingers 100 are spaced apart from each other and are distributed along a full length of the cross member 98 and the collar 96 is positioned between a respective pair of the fingers 100.

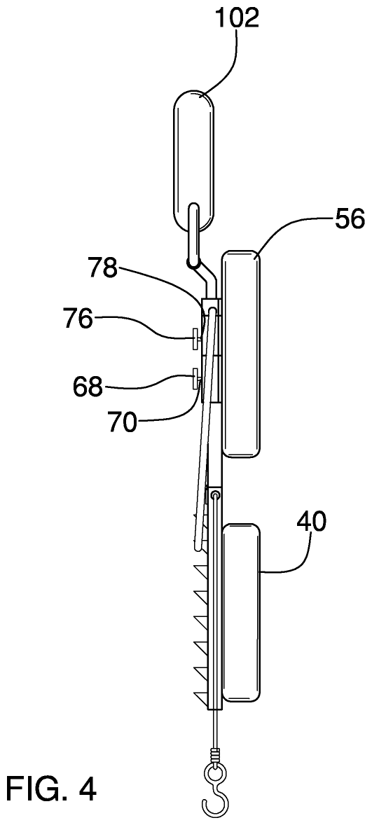

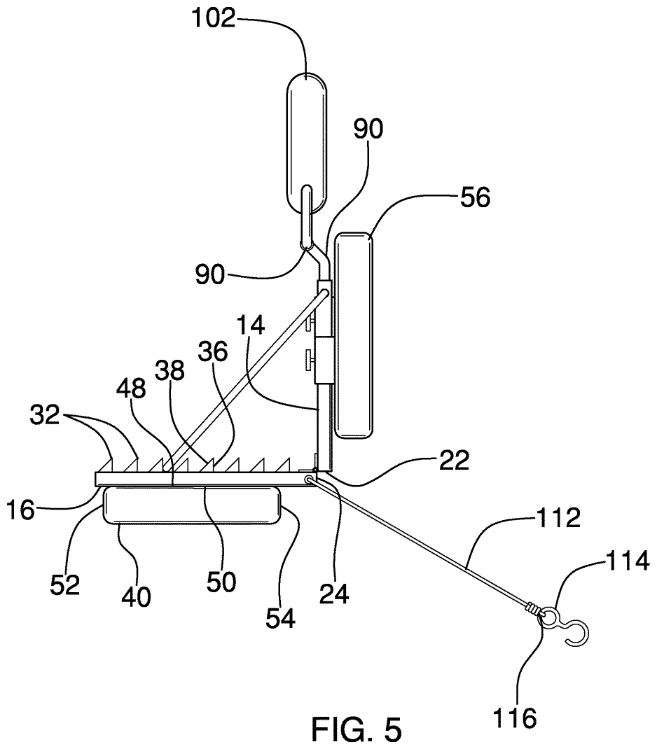

A face cushion 102 is coupled to the face cushion bracket 82 to support the user's face 104 when the user 44 is seated in the chair 46. The face cushion 102 has a primary end 106 and a secondary end 108 and the face cushion 102 is curved between the primary end 106 and the secondary end 108 having the primary end 106 being spaced from the secondary end 108. Each of the primary end 106 and the secondary end 108 is coupled to a distal end 110 of a respective one of the plurality of fingers 100 on the cross member 98 of the face cushion bracket 82 such that the face cushion 102 curves upwardly from the face cushion bracket 82. As is most clearly shown in FIGS. 4 and 5, the upper portion 94 is spaced forwardly from the lower portion 92 such that the face cushion 102 is spaced forwardly from the torso cushion 56 thereby facilitating the user 44 to be ergonomically positioned on the torso cushion 56 and the face cushion 102.

A pair of lanyards 112 is provided and each of the lanyards 112 is each attached to the frame 12. Each of the lanyards 112 is attached to a respective one of the second members 16 of the frame 12 at a point that is located adjacent to an intersection between the second members 16 of the frame 12 and the first members 14 of the frame 12. A pair of hooks 114 is each coupled to a distal end 116 of a respective one of the lanyards 112. Each of the hooks 114 can be attached to the chair 46 thereby inhibiting the frame 12 from moving a pre-determined distance from the chair 46. Additionally, each of the hooks 114 curves rearwardly toward the distal end 116 of the respective lanyard 112 thereby facilitating the hooks 114 to extend around a structural element of the chair 46.

In use, the user 44 is seated in the chair 46 and the frame 12 is positioned to facilitate the torso cushion 56 to be positioned against the user's torso 58 and the leg cushion 40 to rest upon the user's thighs 42. Additionally, the support bracket 18 is positioned on respective pairs of stops 32 to orient the torso cushion 56 at a desired angle and the hook on each of the lanyards 112 is secured to the chair 46. The face cushion bracket 82 is adjusted to position the face cushion 102 at the optimal position to support the user's face 104. In this way the user 44 is retained in a forward leaning position to receive a back massage. Thus, the user 44 can receive a professional massage while seated in a chair of any conventional design rather than having to employ specialized equipment.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable massage support device for facilitating a user to be supported in a seated position for receiving a back massage, said device comprising:
a frame having a pair of first members being hingedly coupled to a pair of second members, said frame including a support bracket being pivotally coupled to said pair of first members, said support bracket being positionable to engage a respective one of said plurality of engagement points on said pair of second members for retaining said pair of first members at an adjustable angle with said pair of second members;
a leg cushion being attached to said pair of second members of said frame wherein said leg cushion is configured to rest upon a user's thighs when the user is seated in a chair;
a torso cushion being slidably disposed on said pair of first members wherein said torso cushion is configured to have the user's torso rest against said torso cushion when the user is seated in the chair thereby orienting the user in a preferred orientation to receive a back massage, said torso cushion being adjustable on said pair of first members wherein said torso cushion is configured to accommodate various sizes of users;
a face cushion bracket being removably attachable to said torso cushion having said face cushion bracket extending upwardly from said torso cushion; and
a face cushion being coupled to said face cushion bracket wherein said face cushion is configured to support the user's face when the user is seated in the chair.

2. The device according to claim 1, wherein:
a lower end of each of said pair of first members is hingedly attached to a rear end of a respective one of said pair of second members;
said leg cushion has an upper surface being attached to a bottom surface of said pair of second members, each of said pair of second member extending outwardly beyond each of a forward side and a rear side of said leg cushion;
said support bracket has a center member extending between and being perpendicularly oriented with a pair of outward members;
said support bracket includes a pair of feet extending laterally away from a respective one of said outward members having said feet being directed toward each other;
each of said pair of feet is distally located with respect to said center member;
each of said pair of feet extends laterally through a respective one of said first members of said frame such that said center member rests on said pair of second members;
said frame includes a plurality of stops each extending upwardly from a top surface of a respective one of said second members such that said plurality of stops defines said plurality of engagement points; and
said stops being spaced apart from each other and being distributed along a full length of said respective second member.

3. The device according to claim 2, wherein:
each of said plurality of stops has a back edge being perpendicularly oriented with said top surface of said respective second member and a front edge sloping between said back edge and said top surface; and
said support bracket is positionable in a deployed position having said center member resting against said back edge of a respective pair of said stops for retaining said pair of first members at a selected angle with said pair of second members.

4. The device according to claim 1, wherein:
said device includes a pair of first sleeves, each of said first sleeves being attached to a rear surface of said torso cushion;
each of said pair of first sleeves is oriented to extend along a line extending between an upper side and a lower side of said torso cushion;
each of said pair of first sleeves is spaced apart from each other and is aligned with each other on said rear surface; and
each of said pair of first sleeves slidably receives a respective one of said first members of said frame for slidably attaching said torso cushion to said pair of first members thereby facilitating said torso cushion to be slid upwardly or downwardly on said pair of first members.

5. The device according to claim 4, wherein:
said device includes a pair of first knobs, each of said pair of first knobs including a threaded shaft which extends through an outer wall of a respective one of said pair of first sleeves;
said threaded shaft of each of said first knobs compresses against said first member in said respective first sleeve when said first knobs are tightened for retaining said torso cushion at a desired position along said pair of first members; and
said threaded shaft of each of said first knobs is urged away from said respective first member when said first knobs are loosened to facilitate said torso cushion to be adjusted on said first members.

6. The device according to claim 4, further comprising:
a second sleeve being attached to said rear surface of said torso cushion, said second sleeve being positioned between said pair of first sleeves, said second sleeve being oriented parallel to said pair of first sleeves, a distance between said second sleeve and said upper side of said torso cushion being less than a distance between said pair of first sleeves and said upper side;
a first knob having a threaded shaft; and
a second knob having a threaded shaft which extends through an outer wall of said second sleeve.

7. The device according to claim 6, wherein:
said face cushion bracket comprises an attaching member having a coupled end and a free end;
said attaching member has a pair of bends forming angles being congruent with each other thereby defining a lower portion being oriented parallel to an upper portion;
said free end is associated with said lower portion;
said coupled end is associated with said upper portion;
said lower portion is insertable through said second sleeve; and
said threaded shaft of said second knob compresses against said lower portion when said second knob is tightened for retaining said lower portion at a selected height in said second sleeve.

8. The device according to claim 7, wherein said face cushion bracket includes:
a collar being attached to said coupled end having said collar being perpendicularly oriented with said upper portion of said attaching member; and
a cross member extending through said collar such that said cross member is perpendicularly oriented with said upper portion of said attaching member, said cross member having a plurality of fingers each extending upwardly from said cross member, said fingers being spaced apart from each other and being distributed along a full length of said cross member, said collar being positioned between a respective pair of said fingers.

9. The device according to claim 8, wherein said face cushion has a primary end and a secondary end, said face cushion being curved between said primary end and said secondary end having said primary end being spaced from said secondary end, each of said primary end and said secondary end being coupled to a distal end of a respective one of said plurality of fingers on said cross member of said face cushion bracket such that said face cushion curves upwardly from said face cushion bracket.

10. The device according to claim 1, further comprising:
a pair of lanyards, each of said lanyards being attached to said frame, each of said lanyards being attached to a respective one of said second members of said frame at a point located adjacent to an intersection between said second members of said frame and said first members of said frame; and
a pair of hooks, each of said hooks being coupled to a distal end of a respective one of said lanyards wherein each of said hooks is configured to be attached to the chair thereby inhibiting said frame from moving a pre-determined distance from the chair, each of said hooks curving rearwardly toward said distal end of said respective lanyard wherein said hooks are configured to extend around a structural element of the chair.

11. A portable massage support device for facilitating a user to be supported in a seated position for receiving a back massage, said device comprising:
a frame having a pair of first members being hingedly coupled to a pair of second members, said frame including a support bracket being pivotally coupled to said pair of first members, said support bracket being positionable to engage a respective one of said plurality of engagement points on said pair of second members for retaining said pair of first members at an adjustable angle with said pair of second members, a lower end of each of said pair of first members being hingedly attached to a rear end of a respective one of said pair of second members, said support bracket having a center member extending between and being perpendicularly oriented with a pair of outward members, said support bracket including a pair of feet extending laterally away from a respective one of said outward members having said feet being directed toward each other, each of said pair of feet being distally located with respect to said center member, each of said pair of feet extending laterally through a respective one of said first members of said frame such that said center member rests on said pair of second members, said frame including a plurality of stops each extending upwardly from a top surface of a respective one of said second members such that said plurality of stops defines said plurality of engagement points, said stops being spaced apart from each other and being distributed along a full length of said respective second member, each of said plurality of stops having a back edge being perpendicularly oriented with said top surface of said respective second member and a front edge sloping between said back edge and said top surface, said support bracket being positionable in a deployed position having said center member resting against said back edge of a respective pair of said stops for retaining said pair of first members at a selected angle with said pair of second members;
a leg cushion being attached to said pair of second members of said frame wherein said leg cushion is configured to rest upon a user's thighs when the user is seated in a chair, said leg cushion having an upper surface being attached to a bottom surface of said pair of second members, each of said pair of second member extending outwardly beyond each of a forward side and a rear side of said leg cushion;
a torso cushion being slidably disposed on said pair of first members wherein said torso cushion is configured to have the user's torso rest against said torso cushion when the user is seated in the chair thereby orienting the user in a preferred orientation to receive a back massage, said torso cushion being adjustable on said pair of first members wherein said torso cushion is configured to accommodate various sizes of users;
a pair of first sleeves, each of said first sleeves being attached to a rear surface of said torso cushion, each of said pair of first sleeves being oriented to extend along a line extending between an upper side and a lower side of said torso cushion, each of said pair of first sleeves being spaced apart from each other and being aligned with each other on said rear surface, each of said pair of first sleeves slidably receiving a respective one of said first members of said frame for slidably attaching said torso cushion to said pair of first members thereby facilitating said torso cushion to be slid upwardly or downwardly on said pair of first members;
a pair of first knobs, each of said pair of first knobs including a threaded shaft which extends through an outer wall of a respective one of said pair of first sleeves, said threaded shaft of each of said first knobs compressing against said first member in said respective first sleeve when said first knobs are tightened for retaining said torso cushion at a desired position along said pair of first members, said threaded shaft of each of said first knobs being urged away from said respective first member when said first knobs are loosened to facilitate said torso cushion to be adjusted on said first members;
a second sleeve being attached to said rear surface of said torso cushion, said second sleeve being positioned between said pair of first sleeves, said second sleeve being oriented parallel to said pair of first sleeves, a distance between said second sleeve and said upper side of said torso cushion being less than a distance between said pair of first sleeves and said upper side;
a second knob having a threaded shaft which extends through an outer wall of said second sleeve;
a face cushion bracket being removably attachable to said torso cushion having said face cushion bracket extending upwardly from said torso cushion, said face cushion bracket comprising:
an attaching member having a coupled end and a free end, said attaching member having a pair of bends forming angles being congruent with each other thereby defining a lower portion being oriented parallel to an upper portion, said free end being associated with said lower portion, said coupled end being associated with said upper portion, said lower portion being insertable through said second sleeve, said threaded shaft of said second knob compressing against said lower portion when said second knob is tightened for retaining said lower portion at a selected height in said second sleeve;
a collar being attached to said coupled end having said collar being perpendicularly oriented with said upper portion of said attaching member; and
a cross member extending through said collar such that said cross member is perpendicularly oriented with said upper portion of said attaching member, said cross member having a plurality of fingers each extending upwardly from said cross member, said fingers being spaced apart from each other and being distributed along a full length of said cross member, said collar being positioned between a respective pair of said fingers;
a face cushion being coupled to said face cushion bracket wherein said face cushion is configured to support the user's face when the user is seated in the chair, said face cushion having a primary end and a secondary end, said face cushion being curved between said primary end and said secondary end having said primary end being spaced from said secondary end, each of said primary end and said secondary end being coupled to a distal end of a respective one of said plurality of fingers on said cross member of said face cushion bracket such that said face cushion curves upwardly from said face cushion bracket;
a pair of lanyards, each of said lanyards being attached to said frame, each of said lanyards being attached to a respective one of said second members of said frame at a point located adjacent to an intersection between said second members of said frame and said first members of said frame; and
a pair of hooks, each of said hooks being coupled to a distal end of a respective one of said lanyards wherein each of said hooks is configured to be attached to the chair thereby inhibiting said frame from moving a pre-determined distance from the chair, each of said hooks curving rearwardly toward said distal end of said respective lanyard wherein said hooks are
